(19) United States
(12) Patent Application Publication
(10) Pub. No.: US 2003/0147370 A1
(43) Pub. Date: Aug. 7, 2003

(54) Inter Node B serving HS-DSCH cell change mechanism in a high speed wireless communication system

(76) Inventor: Chih-Hsiang Wu, Hsin-Tien City (TW)

Correspondence Address: KAO H. LU, 686 LAWSON AVE, HAVERTOWN, PA, 19083, US

(21) Appl. No.: 10/351,186

(22) Filed: Jan. 25, 2003

Related U.S. Application Data
(60) Provisional application No. 60/354,724, filed on Feb. 5, 2002.

(51) Int. Cl. H04J 3/24

(52) U.S. Cl. 370/338; 370/349

(57) ABSTRACT

This invention uses proper RRC procedures to invoke a RLC re-establishment function in UE and UTRAN to initialize state variables, configuration parameters and synchronize HFNs in UM RLC transmitter and receiver in an Inter Node B Serving HS-DSCH Cell Change procedure.

### CROSS REFERENCE APPLICATION

This application claims priority from U.S. Provisional Patent Application No. 60/354,724 filed on Feb. 5, 2002.

### BACKGROUND

This invention relates to wireless communication. More particularly, this invention relates to a HS-DSCH cell change mechanism in a high speed wireless communication system.

The High Speed Downlink Packet Access (HSDPA) between UTRAN and UEs relies on a new transport channel, the High Speed Downlink Shared Channel (HS-DSCH) and techniques such as adaptive modulation and hybrid ARQ (HARQ) to achieve high throughput, reduce delay and achieve high peak rate.

In the UTRAN side, there is one MAC-hs entity for each cell that supports HS-DSCH transmission. The MAC-hs is responsible for handling the data transmitted on the HS-DSCH. The MAC-hs manages the physical resources allocated for HSDPA through four entities: 1. The flow control entity, the entity regulates layer 2 signalling latency and reduces discarded and retransmitted data as a result of HS-DSCH congestion. 2. The scheduling/priority handling entity, it manages HS-DSCH resources between HARQ entities and data flows according to the priority. 3. The HARQ entity, this entity consists of all the HARQ processes (peer state machines capable of achieving error correction by retransmission). And 4. TFRI selection entity, it selects an appropriate transport format and resources combination for the data to be transmitted on HS-DSCH.

In the UE side, UE MAC-hs comprises four entities for HSDPA functions. First, the HARQ entity is responsible for handling the MAC functions relating to the HARQ protocol. The HARQ functional entity of the HARQ entity handles all the tasks that are required for hybrid ARQ and it is responsible for generating ACKs or NACKs. And the reordering queue distribution function of the HARQ entity routes the MAC-hs PDUs to the correct reordering buffer based on the Queue ID. Second, the reordering entity reorders received MAC-hs PDUs according to their TSN. Then, MAC-hs PDUs with consecutive TSNs are delivered to the disassembly function upon reception. Meanwhile, MAC-hs PDUs are not delivered to the disassembly function if MAC-hs PDUs with lower TSN are missing. Third, there is one reordering entity for each Queue ID configured at the UE. And fourth, the disassembly entity is responsible for the disassembly of MAC-hs PDUs.

Because a UE (such as mobile phone) can be transferred from location to location while it is in communicating with a UTRAN, therefore, it is important for a wireless system to have the mobile capacity for HSDPA. Currently, a system achieves the mobility in HSDPA by using a serving HS-DSCH Cell Change procedure to switch the connecting physical channels(s) between UE and UTRAN in the network. This procedure transfers a serving HS-DSCH radio link belonging to the source HS-DSCH cell to a new radio link of the target HS-DSCH cell. If such procedure is performed with relocating the Serving HS-DSCH Node B, it is called an Inter Node B serving HS-DSCH cell change, shown in FIG. 1; if without relocating the Serving HS-DSCH Node B, then it is called an Intra Node B serving HS-DSCH cell change.

Moreover, the handover procedure can be further divided into two kinds. First, an unsynchronized handover, this kind handover means either sides of a HSDPA will start and stop HS-DSCH transmission and reception as soon as possible. Although it could minimize the handover delay ΔT_{HO} but it is generally more difficult to obtain knowledge about the exact time concurrent whether both UE and network are ready for transmission and reception. Therefore this method has difficulty to avoid the problem of transmissions before the receiver is ready. Thus unsynchronized handover is mostly suitable for active set update with radio link addition where communication is ensured on the existing old radio links while a new link is set up. Second, a synchronized handover, the network selects a certain time to start and stop of HS-DSCH transmission and reception for both sides to be performed. A transmission handover in the source cell can be accomplished until the required resources in the target Node B are prepared. FIGS. 2 and 3 illustrate timing at synchronized serving HSD-DSCH cell change.

In general, an Inter-Node B synchronized serving HS-DSCH cell change after Active Set Update is a two-step procedure, first, adding/establishing a radio link between UE and the target Node B, where the term of establishing a radio link means for Aactive Setup Update. Second, synchronizing a serving HS-DSCH cell change.

At the first step, the system performs an Active Set Update that adds a radio link between UE and the target Node Bas shown in FIG. 4. There are various processes that are sequentially performed during an Aactive Set Update of an inter-Node B serving HS-DSCH cell change where the new cell added to the active set is assumed to become the serving HS-DSCH cell in the second step. The system performs a synchronized serving HS-DSCH cell change in the second step.

In the second step, the HARQ entities located in the source HS-DSCH Node B belonging to the specific UE are deleted and new HARQ entities in the target HS-DSCH Node B are established. Without adding any improvements over the current MAC-hs buffer management method in the RLC (Radio Link Control) environment, all the MAC-hs PDUs buffered in the source Node-B may be lost. Because during the Node B switching process, sometime two or more consecutive MAC-hs data blocks (90 RLC PDUs in one block) in RLC unacknowledged mode (UM) could be lost. The RLC ciphering sequence number in UM defined in the prior art includes a 7-bit sequence number, which holds values of 0-127 128 values, accompanied with the UM PDU and a 25 bits Hyper Frame Number (HFN) managed locally to track in-coming and out-going UM PDUs. At the situation of lost two or more MAC-hs data blocks (more than 128 RLC PDUs) would result in a loss of synchronization of peer RLC entities. Because a regular data ciphering is relying on the increment of the RLC ciphering sequence numbers, whenever there is more than 128 consecutive PDUs lost that causes the 7-bits sequence number wrap-around, there would be a loss of synchronization between the RLC ciphering sequence numbers in UM RLC transmitter and receiver.

Consequentially, the loss of synchronization between the peer RLC entity ciphering sequence numbers will cause UM RLC PDUs incorrectly deciphered in the UE side. According to the prior art, there is no quick mechanism to re-synchronize between transmitter and receiver in RLC UM mode. Re-synchronization can only be solved by upper layers (e.g. Application layer) to terminate the existing connection and re-initiate a new connection. UM RLC transmitter does not stop transmitting PDUs until upper layers are aware of its abnormal connection. It wastes a lot of radio resources in this case. On the contrary, this invention by utilizing a few existing system procedures ensures the re-synchronization of the HFNs between the UE and the UTRAN to avoid the above-discussed problem.

Referring back to FIG. 4, in the current Inter Node B cell change process, the UE periodically or conditionally transmits a MEASUREMENT REPORT message containing intra-frequency measurement results to the SRNC in step 10. The SRNC will determine the need for the combined radio link addition and serving HS-DSCH cell change based on received measurement reports (step 12).

At the steps 14-22, the SRNC establishes the new radio link in the target Node B for the dedicated physical channels and transmits an ACTIVE SET UPDATE message to the UE. The ACTIVE SET UPDATE message includes the necessary information for establishment of the dedicated physical channels in the added radio link in steps 14, 16 and 18 (but not the HS-PDSCH). When the UE has added the new radio link it returns in step 22 an ACTIVE SET UPDATE COMPLETE message.

Next, the SRNC will carry on with the step of the serving HS-DSCH cell change. Both the source and target Node Bs are first prepared for execution of the handover at the activation time indicated with CPHY-RL-Commit-REQ primitive (step 40). Then the SRNC sends a TRANSPORT CHANNEL RECONFIGURATION message in step 42, which indicates the target HS-DSCH cell and the activation time to the UE. The message may also include a configuration of transport channel related parameters for the target HS-DSCH cell, including an indication to reset the MAC-hs entity.

Since the source and the target HS-DSCH cells are controlled by different Node Bs, MAC-hs entities in the source and the target Node Bs need to be released and setup, respectively, which are assumed to be done with CMAC-HS-Release-REQ (step 24) and CMAC-HS-Setup-REQ (step 32) primitives. These MAC-hs control primitives are assumed to be carried on the same NBAP/RNSAP messages, which carry the CPHY-RL-Reconfig-REQ primitives (steps 26, 28, 30, 34, 36 and 40). Execution of release and setup of MAC-hs entities shall also be performed at the indicated activation time. When the UE has completed the serving HS-DSCH cell change it returns a TRANSPORT CHANNEL RECONFIGURATION message in step 48 to the network.

### SUMMARY

To avoid UM HFNs unsynchronization during HSDPA between UE and UTRAN in a wireless communication system, this invention uses proper RRC procedures to invoke a RLC re-establishment function in UE and UTRAN to initialize state variables, configuration parameters and synchronize HFNs.

### BRIEF DESCRIPTION OF THE DRAWINGS

Following drawings with reference numbers and exemplary embodiments are referred for explanation purpose.

FIG. 1 illustrates a simple diagram of an Inter-Node B serving HS-DSCH cell change;

FIG. 2 illustrates timing relationships at serving HS-DSCH cell change;

FIG. 3 illustrates various timing relationships at synchronized serving HS-DSCH cell change;

FIG. 4 illustrates process steps in an Inter-Node B synchronized serving HS-DSCH cell change after an active set update;

FIG. 5 illustrates an example of additional process steps suggested by this invention in a UM RLC re-establishment during handover.

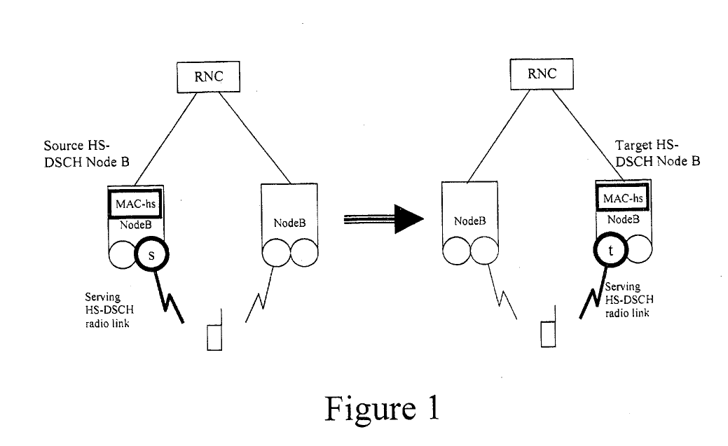

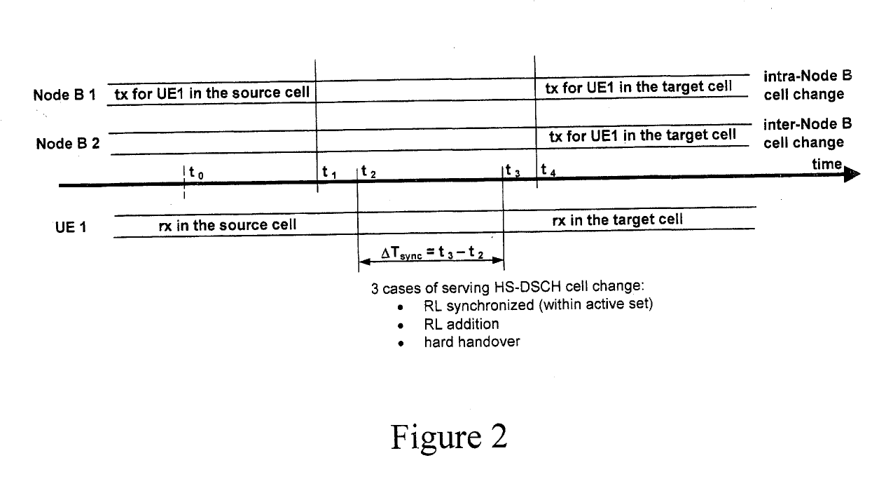

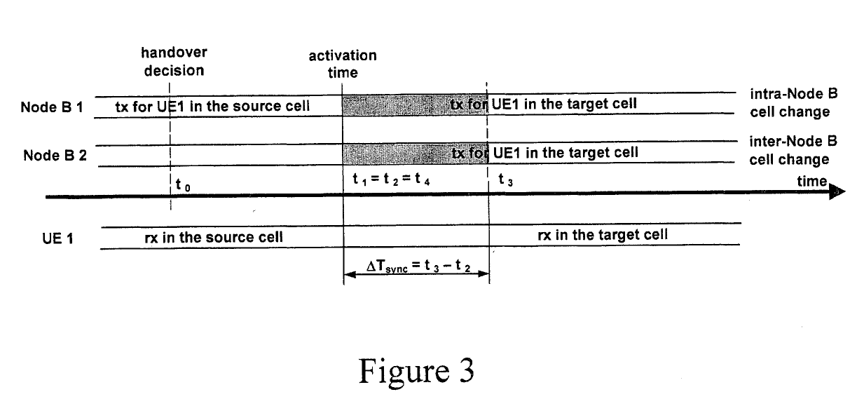

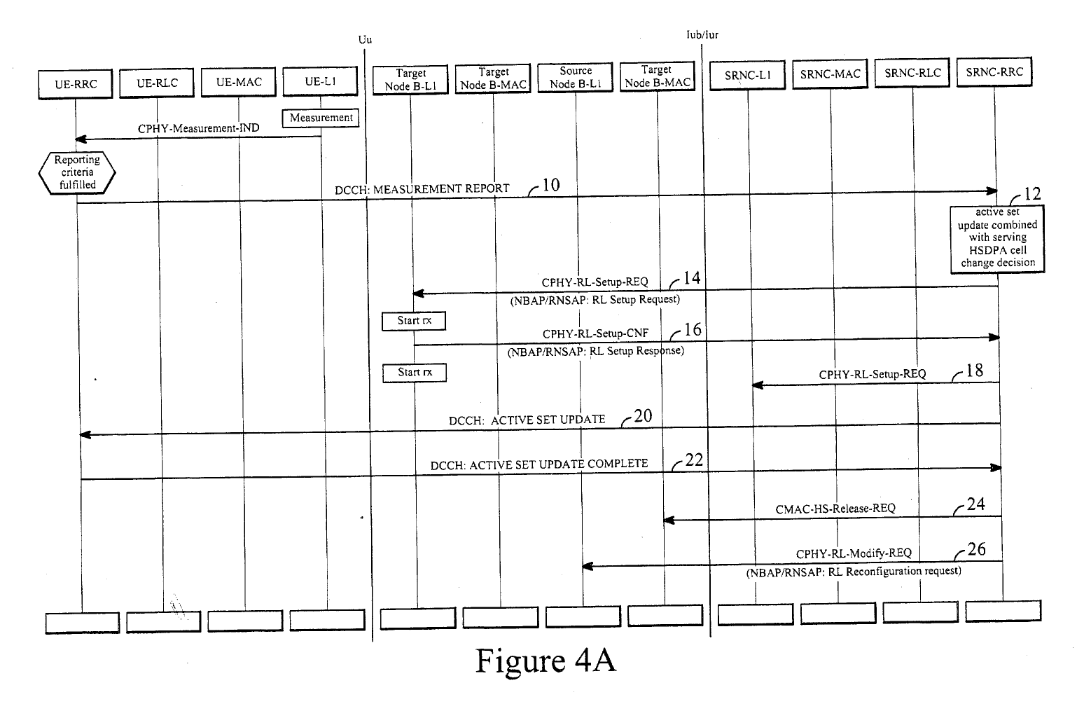

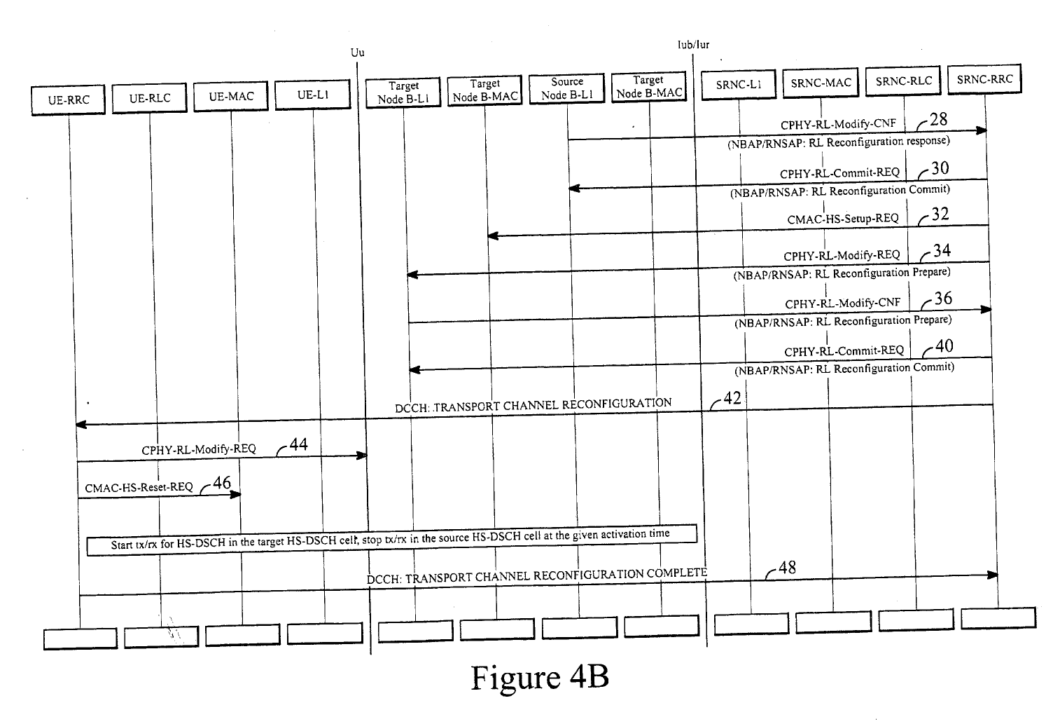

### DETAIL DESCRIPTION OF THE INVENTION

There are many existing RRC procedures, such as the physical channel reconfiguration procedure, the transport channel reconfiguration procedure, the radio bearer reconfiguration procedure, the radio bearer setup procedure, the radio bearer release procedure and others can also be used by UTRAN to initialize the synchronization of HFNs between UTRAN and UE.

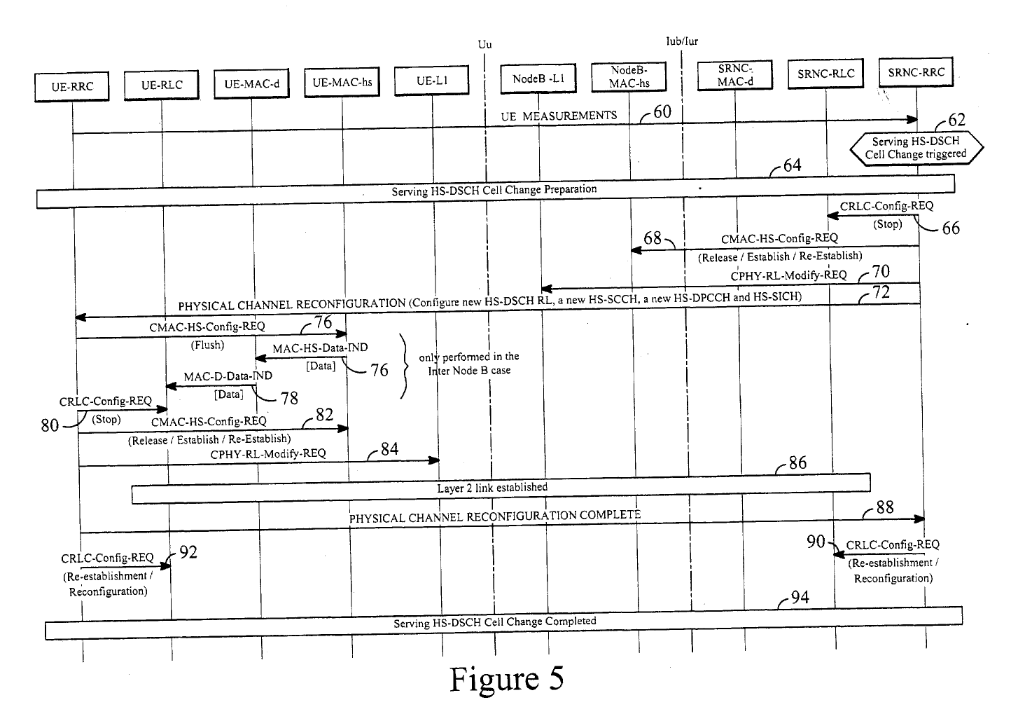

One example of using the physical channel reconfiguration procedure to achieve the intended purpose is illustrated in FIG. 5. The whole procedure will be divided into several stages in chronological order as following for explanation purpose.

1. Once the serving HS-DSCH cell change is triggered in step 62, the SRNC does a few internal maintenance functions, such as sends a CRLC-Config-REQ (Stop) to the RLC in step 66; sends a CMAC-HS-Config-REQ (release/establish/re-establish) to the Node B MAC-hs (step 68); and sends a CPHY-RL-Modify-REQ to the Node B-L1 (Physical Layer) in step 70.

2. The SRNC sends a Physical Channel Reconfiguration message to the UE (step 72).

3. Upon receiving the Physical Channel Reconfiguration message from the SRNC, UE does a few internal maintenance functions, such as sends a CMAC-HS-Config-REQ (Flush) to the UE-MAC-hs (step 74), in responding, the UE-MAC-hs sends back a MAC-HS-DATA-IND (Data) to the UE-MAC-d (step76), which sends a MAC-D-DATA-IND (Data) to the UE-RLC in step 78. Then UE sends a CRLC-Config-REQ (Stop) to the UE-RLC, a CMAC-HS-Config-REQ (release/establish/reestablish) to the UE-MAC-hs, and a CPHY-HS-Config-REQ to the UE-L1 (steps 80, 82 and 84). At this stage, Layer 2 link is established in step 86. UE also generates a START value that will be used to generate a synchronising HFN for the corresponding RLC entity.

4. The UE-RRC sends a PHYSICAL CHANNEL RECONFIGURATION COMPLETE message including the START value to the SRNC-RRC (step88). Afterward, at the SRNC side, UTRAN will assign the START value into the most significant bits of the synchronising HFN, also returns UE an acknowledgement.

5. Once UE receives the returned acknowledgement, it will assign the START value into the most significant bits of the synchronising HFN. Before the serving HS-DSCH cell change process has completed (step 94), both sides, UE and UTRAN, issue CRLC-CONFIG-REQ command including the synchronising HFN from RRC to its corresponding RLC entity to further ensure the synchronization of HFNs between two UE and UTRAN.

In conclusion, the invention uses a proper RRC procedure initialised by UTRAN that further invokes a RLC re-establishment function in UE and UTRAN to initialize state variables, configuration parameters and synchronize HFNs as part of the Inter Node B serving HS-DSCH cell change process.

What is claimed is:

1. A method for improving an inter Node B serving HS-DSCH cell change process of the mobility of HSDPA between UTRAN and UEs in a high speed wireless communication system, wherein UTRAN, upon receiving statuses from a connected UE, deciding to invoke an Inter Node B serving HS-DSCH cell change process in which an UE establishing a new radio link with a target Node B to replace an old radio link with a source Node B, the method comprising the steps of:
at the UE:
receiving a reconfiguration message from the UTRAN that initiates an Inter Node B serving HS-DSCH cell change procedure for the UE;
transmitting a confirmation message to the UTRAN in response to the reconfiguration message;
receiving an acknowledgement that the UTRAN successfully received the confirmation message; and
in response to the acknowledgement, re-establishing a UM RLC entity which receive UM PDUs from HS-DSCH.

2. The method as claimed in claim 1, further comprising the steps of:
generating a START value corresponding to the UM RLC entity that maintaining a HFN;
including the START value in the confirmation message; and
in response to the acknowledgment, the UE assigning the START value to the most significant bits of the HFN for the UM entity which receives UM PDUs from HS-DSCH.

3. The method as claimed in claim 1, wherein a reconfiguration message is a message to invoke a physical channel reconfiguration procedure.

4. The method as claimed in claim 1, wherein a reconfiguration message is a message to invoke a transport channel reconfiguration procedure.

5. The method as claimed in claim 1, wherein a reconfiguration message is a message to invoke a radio bearer reconfiguration procedure.

6. The method as claimed in claim 1, wherein a reconfiguration message is a message to invoke a radio bearer setup procedure.

7. The method as claimed in claim 1, wherein a reconfiguration message is a message to invoke a radio bearer release procedure.

8. A method for improving an inter Node B serving HS-DSCH cell change process of the mobility of HSDPA between UTRAN and UEs in a high speed wireless communication system, wherein UTRAN, upon receiving statuses from a connected UE, deciding to invoke an Inter Node B serving HS-DSCH cell change process in which an UE establishing a new radio link with a target Node B to replace an old radio link with a source Node B, the method comprising the steps of:
at the UTRAN:
sending a reconfiguration message that initiates an Inter Node B serving HS-DSCH cell change procedure for the UE; and
receiving a confirmation message from the UE in response to the reconfiguration message; and
re-establishing a UM RLC entity which transmits UM PDUs through HS-DSCH to the UE.

9. The method as claimed in claim 8, wherein a reconfiguration message is a message to invoke a physical channel reconfiguration procedure.

10. The method as claimed in claim 8, wherein a reconfiguration message is a message to invoke a transport channel reconfiguration procedure.

11. The method as claimed in claim 8, wherein a reconfiguration message is a message to invoke a radio bearer reconfiguration procedure.

12. The method as claimed in claim 8, wherein a reconfiguration message is a message to invoke a radio bearer setup procedure.

13. The method as claimed in claim 8, wherein a reconfiguration message is a message to invoke a radio bearer release procedure.

14. The method as claimed in claim 8 further comprising the steps of:
assigning the received START value contained in the confirmation message to the most significant bits of the HFN for the UM entity which transmits UM PDUs through HS-DSCH to the UE.

15. A method for improving an inter Node B serving HS-DSCH cell change process of the mobility of HSDPA between UTRAN and UEs in a high speed wireless communication system, wherein UTRAN, upon receiving statuses from a connected UE, deciding to invoke an Inter Node B serving HS-DSCH cell change process in which an UE establishing a new radio link with a target Node B to replace an old radio link with a source Node B, the method comprising the steps of:
the UTRAN sending a reconfiguration message that initiates a an Inter Node B serving HS-DSCH cell change procedure for the UE;
the RRC layer of the UE receiving a reconfiguration message from the UTRAN;
the UE transmitting a confirmation message to the UTRAN in response to the reconfiguration message;
the UTRAN receiving the confirmation message from the UE;
the RRC layer of the UE receiving an acknowledgment that the UTRAN successfully received the confirmation message;
in response to the acknowledgment, the RRC layer of the UE re-establishing a UM RLC entity which receives UM PDUs from HS-DSCH; and
the RRC layer of the UTRAN re-establishing a UM RLC entity which transmits UM PDUs through HS-DSCH to the UE.

16. The method as claimed in claim 15, further comprising the steps of:
the UE generating a START value corresponding to the UM RLC entity that maintaining a HFN;
including the START value in the confirmation message;
the UTRAN assigning the received START value contained in the confirmation message to the most significant bits of the HFN for the UM RLC entity which transmits UM PDUs through HS-DSCH to the UE; and
in response to the acknowledgment, the UE assigning the START value to the most significant bits of the HFN for the UM RLC entity which receives UM PDUs from HS-DSCH.

17. A system having means for improving an inter Node B serving HS-DSCH cell change process of the mobility of HSDPA between UTRAN and UEs in a high speed wireless communication system, wherein UTRAN, upon receiving statuses from a connected UE, deciding to invoke an Inter Node B serving HS-DSCH cell change process in which an UE establishing a new radio link with a target Node B to replace an old radio link with a source Node B, the system comprising:
at the UE:
means for receiving a reconfiguration message from the UTRAN by the RRC layer of the UE that initiates an Inter Node B serving HS-DSCH cell change procedure for the UE;
means for transmitting a confirmation message to the UTRAN in response to the reconfiguration message;
means for receiving an acknowledgment that the UTRAN successfully received the confirmation message; and
in response to the acknowledgment, means for re-establishing a UM RLC entity which receives UM PDUs from HS-DSCH. and
at the UTRAN:
means for sending a reconfiguration message that initiates a an Inter Node B serving HS-DSCH cell change procedure for the UE; and
means for receiving a confirmation message from the UE in response to the reconfiguration message; and
means for re-establishing a UM RLC entity which transmits UM PDUs through HS-DSCH to the UE.

18. The system as claimed in claim 17, wherein a reconfiguration message is a message to invoke a physical channel reconfiguration procedure.

19. The system as claimed in claim 17, wherein a reconfiguration message is a message to invoke a transport channel reconfiguration procedure.

20. The system as claimed in claim 17, wherein a reconfiguration message is a message to invoke a radio bearer reconfiguration procedure.

21. The system as claimed in claim 17, wherein a reconfiguration message is a message to invoke a radio bearer setup procedure.

22. The system as claimed in claim 17, wherein a reconfiguration message is a message to invoke a radio bearer release procedure.

23. The system as claimed in claim 17, further comprising:
at the UE:
means for generating a START value corresponding to the UM RLC entity that maintaining a HFN;
means for including the START value in the confirmation message; and
in response to the acknowledgment, means for assigning the START value to the most significant bits of the HFN for the UM RLC entity which receives UM PDUs from HS-DSCH. and
at the UTRAN:
means for assigning the received START value contained in the confirmation message to the most significant bits of the HFN for the UM RLC entity which transmits UM PDUs through HS-DSCH to the UE.
